(19) United States
(12) Patent Application Publication
(10) Pub. No.: US 2023/0163902 A1
(43) Pub. Date: May 25, 2023

(54) SIGNALING PARAMETERS FOR UW-OFDM WAVEFORM

(71) Applicant: QUALCOMM Incorporated, San Diego, CA (US)

(72) Inventors: Hemant SAGGAR, Irvine, CA (US); Iyab Issam SAKHNINI, San Diego, CA (US); Tao LUO, San Diego, CA (US)

(21) Appl. No.: 17/456,364

(22) Filed: Nov. 23, 2021

(51) Int. Cl. H04L 5/00; H04L 27/26

(52) U.S. Cl. CPC H04L 5/0032; H04L 5/0007; H04L 27/2646

(57) ABSTRACT

This disclosure provides systems, devices, apparatus, and methods, including computer programs encoded on storage media, for UW-OFDM waveform techniques. A UE may receive, from a base station, an indication of one or more parameters for the UW-OFDM waveform. The UE may subsequently receive, from the base station, a downlink transmission having the UW-OFDM waveform based on the one or more parameters. A location of redundant subcarriers for the UW-OFDM waveform may be based on at least one of frequency resources allocated for the UE or a combination of the frequency resources allocated to multiple UEs.

### TECHNICAL FIELD

The present disclosure relates generally to communication systems, and more particularly, to unique word orthogonal frequency division multiple access (UW-OFDM) waveform techniques.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may receive, from a base station, an indication of one or more parameters for a unique word orthogonal frequency division multiple access (UW-OFDM) waveform; and receive, from the base station, a downlink transmission having the UW-OFDM waveform based on the one or more parameters, a location of redundant subcarriers for the UW-OFDM waveform based on at least one of frequency resources allocated for a user equipment (UE) or a combination of the frequency resources allocated to multiple UEs.

In another aspect of the disclosure, a method, a computer-readable medium, and an apparatus are provided. The apparatus may transmit, to a UE, an indication of one or more parameters for a UW-OFDM waveform; and transmit, to the UE, a downlink transmission having the UW-OFDM waveform based on the one or more parameters, a location of redundant subcarriers for the UW-OFDM waveform based on at least one of frequency resources allocated for the UE or a combination of the frequency resources allocated to multiple UEs.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a call flow diagram illustrating communications between a UE and a base station.

FIG. 5 illustrates a diagram for symbols of a slot associated with a cyclic prefix (CP) and a guard interval (GI).

FIG. 6 is a diagram that illustrates systematic unique word orthogonal frequency division multiple access (UW-OFDM) generation techniques.

FIG. 7A illustrates allocations of data subcarriers and redundant subcarriers.

FIG. 7B illustrates allocations of data subcarriers and redundant subcarriers.

FIG. 8 is a flowchart of a method of wireless communication at a UE.

FIG. 9 is a flowchart of a method of wireless communication at a UE.

FIG. 10 is a flowchart of a method of wireless communication at a base station.

FIG. 11 is a flowchart of a method of wireless communication at a base station.

FIG. 12 is a diagram illustrating an example of a hardware implementation for an example apparatus.

FIG. 13 is a diagram illustrating an example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, aggregated or disaggregated components, end-user devices, etc. of varying sizes, shapes, and constitution.

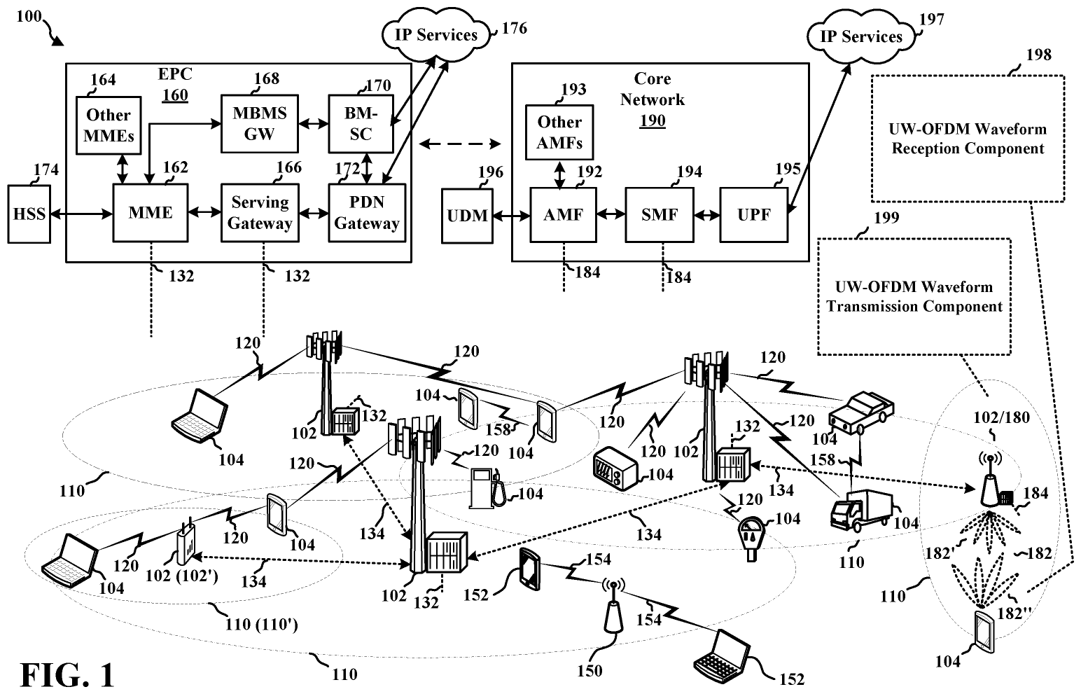

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR2-2, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as a gNB may operate in a traditional sub 6 GHz spectrum, in millimeter wave frequencies, and/or near millimeter wave frequencies in communication with the UE 104. When the gNB operates in millimeter wave or near millimeter wave frequencies, the gNB may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a unique word orthogonal frequency division multiple access (UW-OFDM) waveform reception component 198 configured to receive, from a base station, an indication of one or more parameters for a UW-OFDM waveform; and receive, from the base station, a downlink transmission having the UW-OFDM waveform based on the one or more parameters, a location of redundant subcarriers for the UW-OFDM waveform based on at least one of frequency resources allocated for the UE or a combination of the frequency resources allocated to multiple UEs. In certain aspects, the base station 180 may include a UW-OFDM waveform transmission component 199 configured to transmit, to a UE, an indication of one or more parameters for a UW-OFDM waveform; and transmit, to the UE, a downlink transmission having the UW-OFDM waveform based on the one or more parameters, a location of redundant subcarriers for the UW-OFDM waveform based on at least one of frequency resources allocated for the UE or a combination of the frequency resources allocated to multiple UEs. Although the following description may be focused on 5G NR, the concepts described herein may be applicable to other similar areas, such as LTE, LTE-A, CDMA, GSM, and other wireless technologies.

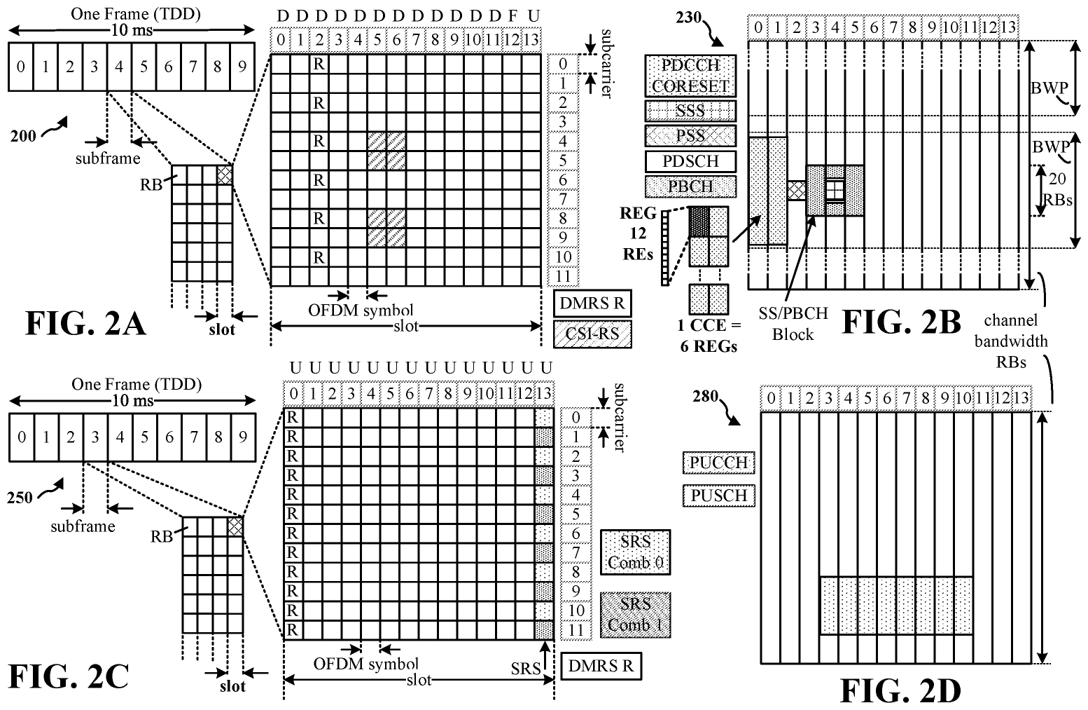

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | Cyclic |
|---|---|---|
| μ | Δƒ = 2^{μ} · 15[kHz] | prefix |
| 0 | 15 | Normal |
| 1 | 30 | Normal |
| 2 | 60 | Normal, |
| | | Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

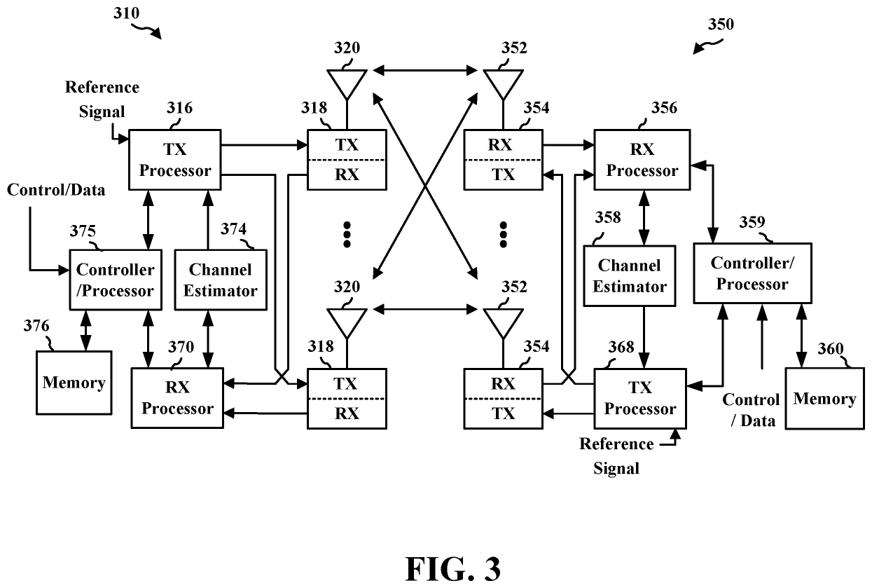

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318 TX. Each transmitter 318 TX may modulate a radio frequency (RF) carrier with a respective spatial stream for transmission.

At the UE 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with the UW-OFDM waveform reception component 198 of FIG. 1.

At least one of the TX processor 316, the RX processor 370, and the controller/processor 375 may be configured to perform aspects in connection with the UW-OFDM waveform transmission component 199 of FIG. 1.

Wireless communication systems may be configured to share available system resources and provide various telecommunication services (e.g., telephony, video, data, messaging, broadcasts, etc.) based on multiple-access technologies such as CDMA systems, TDMA systems, FDMA systems, OFDMA systems, SC-FDMA systems, TD-SCDMA systems, etc. that support communication with multiple users. In many cases, common protocols that facilitate communications with wireless devices are adopted in various telecommunication standards. For example, communication methods associated with eMBB, mMTC, and ultra-reliable low latency communication (URLLC) may be incorporated in the 5G NR telecommunication standard, while other aspects may be incorporated in the 4G LTE standard. As mobile broadband technologies are part of a continuous evolution, further improvements in mobile broadband remain useful to continue the progression of such technologies.

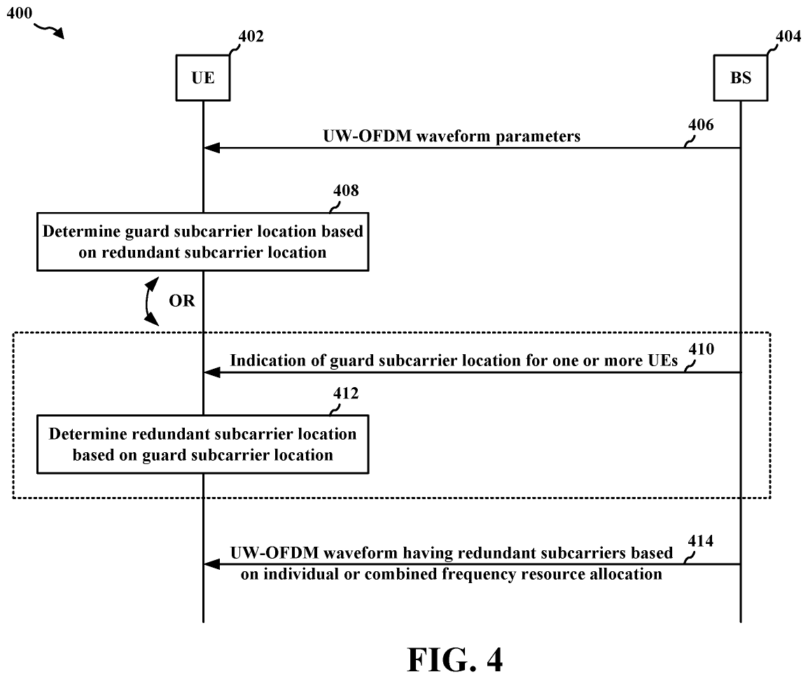

FIG. 4 is a call flow diagram 400 illustrating communications between a UE 402 and a base station 404. At 406, the base station 404 may transmit unique word orthogonal frequency division multiple access (UW-OFDM) waveform parameters to the UE 402. The UW-OFDM waveform parameters may include a time domain length of a guard interval (GI) for the UW-OFDM waveform, a number of redundant subcarriers for the UW-OFDM waveform, a redundant subcarrier location for the UW-OFDM waveform, a guard subcarrier location for the UW-OFDM waveform, a generation technique for the UW-OFDM waveform, a generation mechanism for a zero-tailed (ZT)-OFDM symbol for the UW-OFDM waveform, information about a unique word (UW) for the UW-OFDM waveform, etc.

In a first aspect, the UW-OFDM waveform parameters transmitted, at 406, to the UE 402 may be indicative of redundant subcarrier locations. At 408, if a first redundant subcarrier location corresponds to a top of a data subcarrier allocation and a last redundant subcarrier location corresponds to a bottom of the data subcarrier allocation, the UE 402 may determine a guard subcarrier location based on the redundant subcarrier locations indicated, at 406, via the UW-OFDM waveform parameters. For example, the locations of the first redundant subcarrier and the last redundant subcarrier may define an upper boundary and a lower boundary of the data subcarrier allocation, which may be subtracted from an FFT bandwidth to determine a non-allocated portion of the FFT bandwidth that corresponds to the guard subcarrier locations.

While the location of redundant subcarriers may be indicated, at 406, based on the UW-OFDM waveform parameters, such indication is not necessary for determining the guard subcarrier location. For example, in a second aspect, the base station 404 may transmit, at 410, an indication to the UE 402 of the guard subcarrier location for one or more UEs. The guard subcarriers for the UW-OFDM waveform may correspond to non-allocated frequency resources that are not allocated to the UE 402 or to multiple UEs that include the UE 402. At 412, the UE 402 may determine a redundant subcarrier location based on the guard subcarrier location indicated, at 410, by the base station 404. For example, the guard subcarrier location may correspond to a non-allocated portion of the FFT bandwidth and may be subtracted from the FFT bandwidth to determine a data subcarrier allocation that includes the redundant subcarrier location. The location of the redundant subcarriers within the data subcarrier allocation may be determined based on a mapping of the data subcarrier allocation or the guard subcarrier allocation via a mapping table signaled to the UE. Hence, the location of the redundant subcarriers may not be signaled for each data subcarrier allocation. Alternately, the location of the redundant subcarriers may be signaled explicitly for each data subcarrier allocation.

At 414, the base station 404 may transmit a UW-OFDM waveform to the UE 402 based on the UW-OFDM waveform parameters indicated, at 406, to the UE 402. The UW-OFDM waveform transmitted, at 414, to the UE 402 may be based on individual frequency resource allocations for one or more UEs or a combined frequency resource allocation for the one or more UEs.

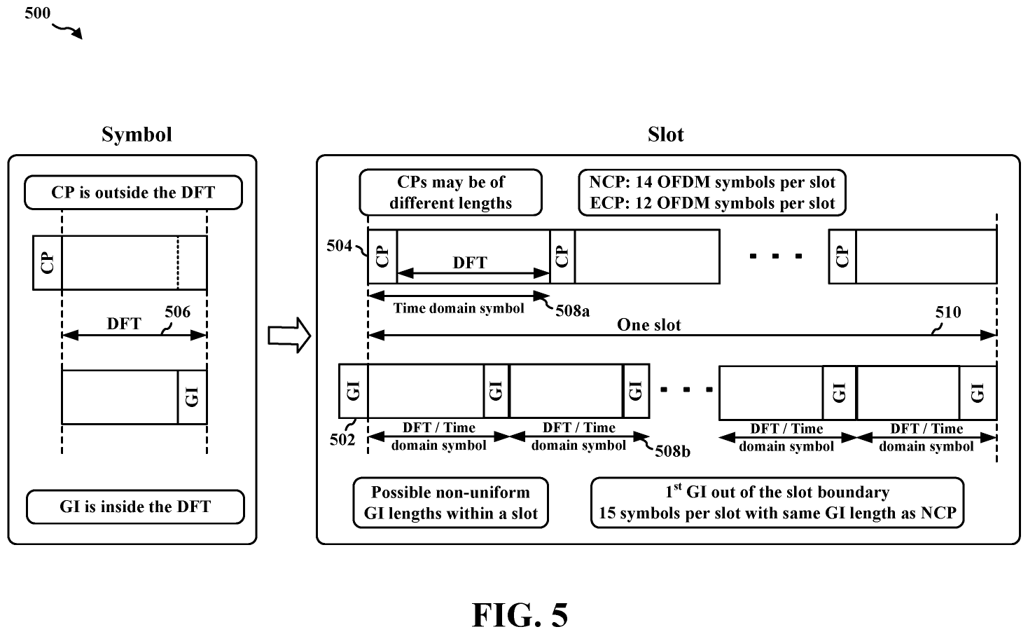

FIG. 5 illustrates a diagram 500 for symbols 508a/508b of a slot 510 associated with a CP length that is fixed within the slot 510 and a GI length that is not fixed within the slot 510. A UW-OFDM waveform may be signaled based on parameters communicated between the base station and the UE. The base station may select one or more parameters for generating the UW-OFDM waveform that the UE may use to decode the UW-OFDM waveform. In examples, multiple UEs may be communicating with the base station based on the UW-OFDM waveform.

Some communications may be based on upper frequency ranges, such as FR4, FR5, etc., for capturing additional bandwidth. FR4 may correspond to frequency ranges up to 114 GHz and FR5 may correspond to frequency ranges up to 300 GHz. As the frequency increases, characteristics of the signal such as phase noise may also increase, which may result in degraded conditions for OFDM subcarriers. In order to provide increased flexibility for adjustments to the multipath channel and/or the phase noise associated with a wireless environment, the CP 504 and the GI 502 may enable a receiver to process the channel multipath based on low complexity algorithms. A CP-based waveform with a fixed CP length may not be adaptable based on multipath channel conditions, which may result in resource waste or an inadequate resource allocation. A GI-based waveform, on the other hand, may have a GI length that may be adjusted based on the multipath channel, which may increase spectral efficiency. While the CP 504 may correspond to a cyclic extension of data samples, the GI 502 may be comprised of any sequence of samples. By allocating predetermined reference signals to the GI portion of a time domain symbol 508b, the receiver may be enabled to perform phase tracking, channel estimation, and other functions that may increase performance at high frequencies. Hence, a GI-OFDM waveform may be utilized for high frequency communications, rather than a CP-OFDM waveform. In examples, GI-OFDM may be referred to interchangeably with UW-OFDM.

CP-OFDM waveforms may be used for physical channels including PDSCH, PUSCH, PUCCH, PDCCH, etc. The length of the CP 504 may be fixed within the slot 510 and may correspond to normal CP (NCP) or extended CP (ECP). The slot 510 may include 14 NCP symbols per slot or 12 ECP symbols per slot. CP-OFDM may be used for higher frequency transmissions (e.g., via an increased number of antennas) associated with a multi-path channel. If the multi-path transmission has a duration that is shorter or longer than the length of the CP 504, reducing or increasing a size of the CP 504 may improve the signal. However, since the CP 504 is located outside a DFT window 506, adjusting the length of the CP 504 may affect the number of symbols 508a that may be included within the slot 510. For example, increasing a size of the CP 504 may reduce the remaining number of symbols 508a that may fit within the slot 510. At higher frequencies, alternatives to CP-OFDM may be configured to provide circular convolution while also providing flexibility for the higher frequency transmissions. Hence, the GI-OFDM waveform may be used for different levels of multi-path transmissions at higher frequencies, instead of CP-OFDM waveforms that may include a predefined CP length.

The GI 502 may differ from the CP 504 in that the GI 502 may be located inside the DFT window 506, which may allow the GI 502 to be flexible in length. That is, each GI 502 within the slot 510 may have a non-uniform length for the GI symbols of the slot 510. The length of the time domain symbol 508b for the GI symbols may be equal to the length of the DFT window 506. In contrast, the CP 504 may be located outside a boundary of the DFT window 506 and may include a predefined length. The length of the time domain symbol 508a for CP symbols may be equal to the DFT window 506 plus the length of the CP 504.

When arranged in succession, both GI symbols and CP symbols may provide circular convolution. The CP 504 may be located at a beginning of each symbol 508a in the succession of symbols to generate a circular convolution window. The GI 502 may be located at an end of each symbol 508b in the succession of symbols to similarly generate the circular convolution window. However, each symbol 508b in the succession of GI symbols may rely on the GI 502 from the previous symbol 508b to provide the circular convolution for the next symbol 508b, since the GI 502 is located at the end of each symbol 508b rather than at the beginning of each symbol 508b. A first GI 502 in the succession of symbols may be located outside the slot boundary. That is, the first GI 502 may correspond to a last symbol of a preceding slot. In further examples, the first GI 502 may be included within the slot 510 (e.g., at a beginning of the slot 510) based on certain GI allocation techniques.

The GI 502 may be independent of a remaining portion of the circular window. Information included in the GI 502 may correspond to all zeros (e.g., an absence of information) or to a specific signal independent of associated data. The specific signal may correspond to a UW. The information included in the GI 502 may be arbitrary information that is used for channel estimation or other purposes. The length of the GI 502 may be increased or decreased without changing the total length of the time domain symbol 508b. Since the GI 502 is inside the DFT window 506, the GI 502 may be increased/decreased as-needed based on a size of the remaining portion of the DFT window 506, so that a sum of the two portions still add up to the total length of the DFT window 506. Such techniques may reduce overhead associated with using the GI 502 for different levels of multi-path transmission.

The UW may be used to indicate time, frequency, or phase lock; time, frequency, or phase tracking; channel estimation; a beam-switching gap; etc. A UW-OFDM with a UW length Nᵤ in time may be generated by providing Nᵣ redundant (e.g., dependent) subcarriers in frequency, where Nᵣ and Nᵤ may be selected waveform parameters. The UW-OFDM waveform may include one or more parameters associated with waveform generation/transmission at the base station and waveform reception at the UE. The one or more parameters may be indicative of a location of redundant subcarriers, redundancy generation techniques, UW samples, etc. The base station may signal the one or more parameters associated with the UW-OFDM waveform to the UE for communicating with the UE based on the UW-OFDM waveform.

A first number of symbols 508a within the slot 510 may be associated with the CP 504 and a second number of symbols 508b within the slot 510 may be associated with the GI 502. If the CP 504 and the GI 502 are maintained at constant lengths, up to 15 GI symbols may fit within the slot 510, compared to 14 CP symbols that may fit within the slot 510. The GI 502 used for a first symbol of the slot 510 may correspond to a last symbol of a previous slot. Such techniques for the GI 502 may allow the first symbol of the slot 510 to have circular convolution. Thus, even though more GI symbols may fit within the slot 510, the first symbol of the slot 510 may be based on an association to a previous slot. Nevertheless, additional overhead may not be generated due to the last symbol of the previous slot including a GI 502.

Both the GI 502 and the CP 504 may convert a linear convolution of Tx symbols for a channel to a circular convolution (e.g., based on a one-tap frequency domain equalizer (FDE) at the receiver). Both the GI 502 and the CP 504 may also reduce inter-symbol interference and maintain symbol/slot alignment. The CP 504 may be slot-contained based on random data, but may not be easily adjusted in size. The GI 502 may not be slot-contained, but may be associated with a predetermined signal used for synchronization or channel estimation and may be adjusted in size without changing a duration of the time domain symbol 508b.

Generation of a UW-OFDM waveform may be based on systematic techniques or non-systematic techniques. Systematic techniques may be based on separate data and redundant subcarriers at an IFFT input. Redundant subcarriers may have a higher average power than data subcarriers, which may be based on a transformation used to generate the redundant subcarriers. Systematic techniques may also attempt to optimize a position of the redundant subcarriers. In non-systematic techniques, each subcarrier may include a combination of data and redundancy subcarriers (e.g., without differentiation between the redundancy and the data). As a result, each of the non-guard subcarriers may be associated with similar average powers, which may reduce a total energy in comparison to systematic approaches.

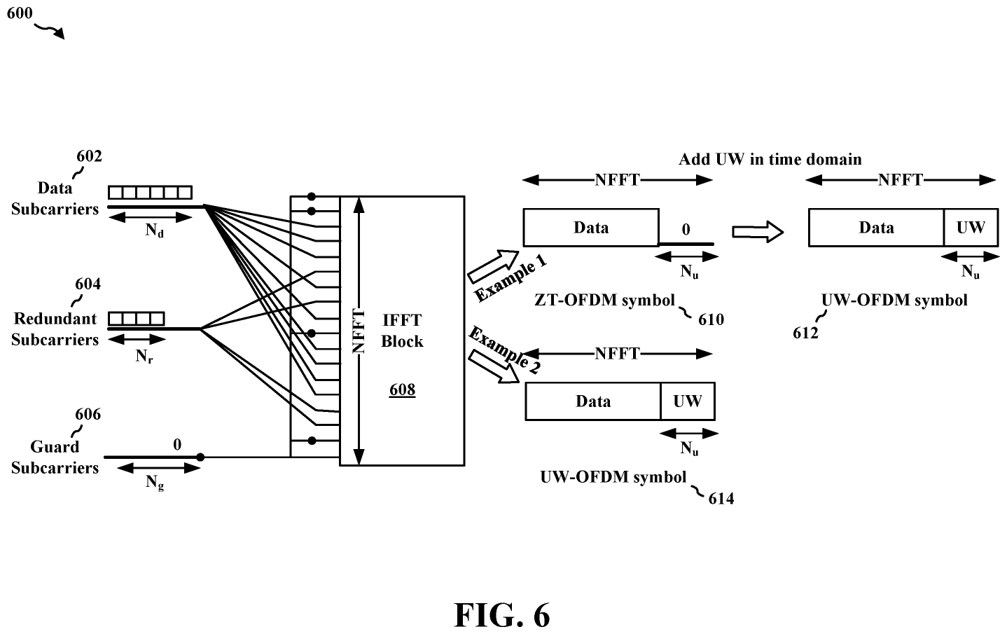

FIG. 6 is a diagram 600 that illustrates systematic UW-OFDM generation techniques. Multiple algorithms may be executed for attempting to generate/determine locations of redundant subcarriers 604 based on a UW being added to a symbol in time domain or frequency domain. The UW may correspond to any information/samples at an end of a symbol (e.g., UW-OFDM symbol 612/614) that is independent of data in the symbol. The UW may be of length Nᵤ. Data modulation at an input of an IFFT block 608 may be indicative of a correlation between the subcarriers (e.g., a first number of data subcarriers 602 (N_{d}), a second number of redundant subcarriers 604 (Nᵣ), and a third number of guard subcarriers 606 (N_{g})). Data may be removed from one or more of the data subcarriers 602 to provide the redundant subcarriers 604. The redundant subcarriers 604 may be configured such that, at the output of the IFFT block 608, last Nᵤ samples may be equal to the UW. In another example, the redundant subcarriers 604 may be configured such that the last Nᵤ samples at the output of the IFFT block 608 may be zero. The UW may be added later in the time domain if the UW is to be utilized. Since the IFFT block 608 may correspond to a predetermined operation, a value of the UW may be mapped in time as a function of the input of the IFFT block 608. Regarding allocation of the redundant subcarriers 604, Nᵣ may be less than, equal to, or greater than Nᵤ, as determined by the base station. The redundant subcarriers 604 may be mapped to the data subcarriers 602 based on an equation/matrix.

The UE may determine locations of the redundant subcarriers 604 in association with using the IFFT block 608 to decode the data. Signaling from the base station to the UE may be indicative of a location/mapping of the redundant subcarriers 604 (e.g., uniformly distributed, specific locations, etc.). The UE may determine a generated UW portion of the UW-OFDM symbol 612/614 that follows a data reception for determining the data included in the data reception. For example, after an FFT operation, the UE may subtract/remove the determined UW portion of the UW-OFDM symbol 612/614 to leave only the data portion of the UW-OFDM symbol 612/614 for decoding. Since the UW is unique, signaling indicative of the UW may be provided to the UE.

In a first example, systematic UW-OFDM generation may be based on Nᵣ≥Nᵤ redundant subcarriers 604 at the input of the IFFT block 608, where Nᵤequals a length for the UW that causes the redundancy to generate a ZT-OFDM symbol 610 at the output of the IFFT block 608. The UW may be subsequently added to the data in the time domain to provide the UW-OFDM symbol 612. In a second example, a UW-tailed symbol (e.g., UW-OFDM symbol 614) may be generated in a single step at the output of the IFFT block 608. That is, the UW may be generated directly in the time domain based on the redundancy, rather than the redundancy being used to generate a ZT-OFDM symbol 610 for the UW to be added. The approach used to generate the UW-OFDM waveform may be signaled to the UE, as decoding techniques for the UW-OFDM waveform may be based on the implemented approach (e.g., the UW being added in time domain versus being generated directly based on the redundant subcarriers 604). If the UW is generated directly, the data subcarriers may not be affected, whereas if the UW is added later to a ZT-OFDM symbol in the time domain, the data subcarriers may be affected based on the UW samples being limited in the time domain.

The UW-OFDM waveform may be generated based on a number of steps. For example, the base station may first determine a location of guard (band) subcarriers 606 within a frequency band in association with a non-uniform FFT (NFFT). That is, in addition to the data subcarriers 602 and the redundant subcarriers 604, the guard subcarriers 606 may also be included in the frequency band. Thus, a size of the frequency band may be equal to a first number of the data subcarriers 602 plus a second number of the redundant subcarriers 604 plus a third number of the guard subcarriers 606. The location of the guard subcarriers 606 may be signaled to the UE. Second, the base station may compute/determine a location of the redundant subcarriers 604 in the non-guard band portion of the frequency band to generate a zero-tailed symbol (e.g., ZT-OFDM symbol 610) or a UW-tailed symbol (e.g., UW-OFDM symbol 614). The location of the redundant subcarriers 604 may be optimized based on criteria such as reducing energy on the redundant subcarriers 604.

Third, subcarriers that are neither guard subcarriers 606 nor redundant subcarriers 604 may serve as data subcarriers 602. Fourth, a permutation matrix (matrix P) may be generated that maps the data and redundant tones to specific locations within the frequency band. The mapping may be based on the computed location of the redundant subcarriers 604 and signaled to the UE by the base station. The matrix P may be used to map the redundant subcarriers 604 within the data allocation to prevent a certain increase in symbol energy in the time domain, which may negatively affect performance. Hence, the matrix P may be used to reduce energy at the IFFT output or to reduce a bit error rate (BER).

Fifth, modulated tones may be mapped around the guard subcarriers 606 using a matrix B, which may correspond to a tall matrix of ones and zeros that includes more rows than columns. That is, data/redundant tones may be mapped to the non-guard portion of the frequency band. The matrix B may be based on using modulated carriers as an input for providing the guard subcarriers 606 plus the modulated subcarriers as an output. Each row of matrix B may include all zeros (e.g., if an associated subcarrier corresponds to a guard subcarrier) or may include a single “one” in an entry of the row, in which case the modulated subcarrier indicated by the entry is associated with the row. For example, if there are 3,000 data subcarriers 602, 300 redundant subcarriers 604, and 796 guard subcarriers 606, the matrix B may be of dimensions 4096×3300. Sixth, the IFFT block 608 may provide a time domain symbol that is zero-tailed (e.g., ZT-OFDM symbol 610) or UW-tailed (e.g., UW-OFDM symbol 614). Seventh, the UW may be added in time domain to the ZT-OFDM symbol 610 to provide the UW-OFDM symbol 614.

One or more parameters may be indicated from the base station to the UE for the UE to generate and receive UW-OFDM waveforms. The base station may signal the one or more parameters to the UE when configuring the UE for a UW-OFDM waveform. The one or more parameters may indicate, e.g., a length of a GI in time-domain (Nᵤ), a number of redundant subcarriers 604 (Nᵣ) if different than Nᵤ, a location of the redundant subcarriers 604 based on matrix P, etc. The redundant subcarriers 604 may be used to generate the ZT-OFDM symbol 610 or the UW-OFDM symbol 614. In examples, if an exact location of the redundant subcarriers 604 is signaled to the UE, a number of the redundant subcarriers 604 may not have to be signaled to the UE. The location of the redundant subcarriers 604 may be signaled based on matrix P and the location of the guard subcarriers 606 may be signaled based on matrix B. In matrix B, values of 1 may indicate locations where data is allowed and values of 0 may indicate locations where data is not allowed. Matrix B may also be converted to a vector and signaled to the UE.

The one or more parameters may be further indicative of UW-OFDM generation techniques (e.g., systematic/non-systematic), a ZT-OFDM symbol 610 (e.g., implementation of the first example or the second example), and/or types of UW added to the ZT-OFDM symbol 610 (e.g. specific UW symbols based on Fourier sequences, Zadoff Chu sequences, etc.). The data subcarriers 602 plus the redundant subcarriers 604 plus the guard subcarriers 606 may extend over a total NFFT input to the IFFT block 608. The matrix B, the matrix P, and the UW may correspond to parameters used to calculate values of the redundant subcarriers 604. At the output of the IFFT block 608, the UW may be generated after the data samples, which may be based on the data subcarriers 602.

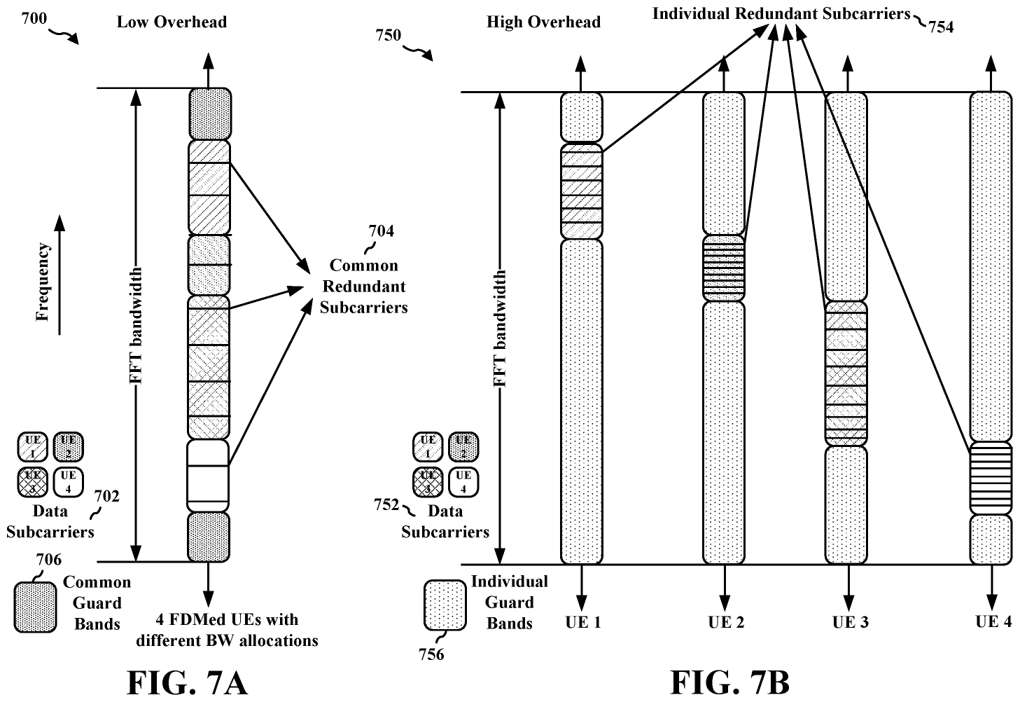

FIGS. 7A-7B illustrate allocations 700-750 of data subcarriers 702/752 and redundant subcarriers 704/754. The location of guard subcarriers 706/756 associated with the allocations 700-750 may be based on matrix P and the locations of the data subcarriers 702/752 and the redundant subcarriers 704/754 may be based on either a joint allocation in time domain or separate time domain allocations. One or more parameters signaled to the UE may also be used to indicate the location of the redundant subcarriers 704 for UE multiplexing.

In the allocation 750, the data subcarrier allocations for UE1, UE2, UE3, and UE4 may include respective sets of individual redundant subcarriers 754. For example, each data allocation for UE1, UE2, UE3, and UE4 may include a same number of redundant subcarriers 754 in association with different time domain instances that correspond to the different UEs. Subcarriers that are located at frequencies of the FFT bandwidth outside the data subcarrier allocations may correspond to guard band subcarriers 756 that do not include the redundant tones. In the allocation 750, each of the UEs may be associated with individual guard band allocations 756. The location of redundant subcarriers 754 may be inferred by each UE based on an individual guard band allocation of each UE. While the allocation 750 may provide less complex signaling for the redundant subcarriers 754 within each data subcarrier allocation, the allocation 750 may have a higher overhead than a joint data allocation for UE1, UE2, UE3, and UE4, where the 4 UEs are FDMed based on different bandwidth allocations. Complexity may also be lowered based on using the redundant tones for data decoding, since the redundant tones may depend on individual data of the UEs, as compared to the joint data allocation for UE1, UE2, UE3, and UE4.

In the allocation 700, the redundant subcarriers 704 may be shared among the FDMed data allocations for UE1, UE2, UE3, and UE4. That is, a set of redundant subcarriers may be distributed across the four data allocations for UE1, UE2, UE3, and UE4 as common redundant tones for a UE multiplexing procedure. Remaining frequencies associated with the FFT bandwidth may correspond to common guard band subcarriers 706 that do not include the redundant subcarriers 704. Each UE may be associated with a common location of the redundant subcarriers 704 that extends across the entire FFT bandwidth, excluding the locations of the guard band subcarriers 706. Redundant subcarrier information may be based on data associated with all the UEs. Hence, the joint allocation/FDMed techniques may have to be configured by the base station. Using redundant tones for data decoding may cause additional computational complexity as compared to individual redundant tones for each UE, since the redundant tones may be a function of the data associated with all the UEs, instead of a single UE.

For the allocation 700, the base station may transmit a signal to each of the 4 UEs to indicate the locations of the 4 respective data allocations. The 4 respective data allocations may be combined to provide an overall FDMed data allocation. The redundant subcarriers 704 may then be allocated within the overall FDMed data allocation of the FFT bandwidth. The UE may receive a signal from the base station over the entire FFT bandwidth and identify the tones that correspond to the redundant subcarriers 704. The redundant subcarriers 704 may be used at the input of an IFFT block to generate the UW or the ZT for a symbol.

Accordingly, in the allocation 700, the redundant subcarriers 704 may be shared among each of the data allocations for the 4 UEs with lower overhead. In other words, the redundant subcarriers 704 may be spaced farther apart by spreading the allocation of the redundant subcarriers 704 across all 4 allocations of the data subcarriers 702. In the allocation 750, each of the data allocations for the respective UEs may include a complete/respective set of redundant tones with higher overhead, as the frequencies associated with the data allocations of the other UEs may be regarded as guard tones, causing each respective set of redundant tones to be compacted into each respective data allocation. In the allocation 750, each UE may have a same number of redundant tones as allocated in the allocation 700, regardless of a bandwidth the data allocation for each UE occupies. Hence, the allocation 750 may be associated with a higher overhead than the allocation 700.

The location of the guard subcarriers 706/756 may be signaled from the base station to the UE. For example, matrix B may be used to indicate the location of the guard subcarriers 706/756. In some examples, a complement of matrix B may indicate the resources allocated to the UEs. If matrix B is common to each of the UEs, matrix B may be signaled to the UEs via RRC, MAC-CE, or DCI.

The locations of the redundant subcarriers 704/754 and the data subcarriers 702/752 may be similarly signaled from the base station to the UE. In examples, if one of the location of the redundant subcarriers 704/754 or the location of the data subcarriers 702/752 is signaled to the UE, the other one of the location of the redundant subcarriers 704/754 or the location of the data subcarriers 702/752 may be determined implicitly based on information associated with matrix B. For example, if the locations of the guard tones, the redundant tones, and the overall allocation is indicated to the UE, the UE may implicitly determine the location of the data tones, given that the data tones may extend/span across the non-guard portions of the overall allocation. Similarly, if the guard tones, the data tones, and the overall allocation is indicated to the UE, the UE may implicitly determine the location of the redundant tones.

The signaling from the base station to the UE may be indicative of the matrix P or the locations of redundant/data tones within the FFT bandwidth. In examples, the signaling from the base station to the UE may be based on a predetermined table that maps matrix B to matrix P. In other words, the location of the redundant tones and the data tones within the FFT bandwidth may be based on the data allocation of the UE through the predetermined table and may not have to be signaled separately from the matrix B. If the base station configures an FFT bandwidth allocation and indicates a location of the tones, the base station may not signal the UE via DCI (e.g., the UE may be signaled via RRC).

The matrix B and the matrix P may be signaled together in certain configurations as a single vector. For example, a product of matrix B and matrix P may be indicative of the locations of the data/redundant tones within a reference frame of the FFT bandwidth window. Instead of signaling the locations of the data/redundant tones within the non-guard portion of the overall allocation, the locations of the data/redundant tones may be signaled within the entire length of the FFT bandwidth. The location of the redundant subcarriers 704/754 (e.g., based on matrix P) may remain the same across multiple UE resource allocations, as matrix P may be based on a union of the multiple UE resource allocations. The location of the redundant subcarriers 704/754 may also change with each resource allocation.

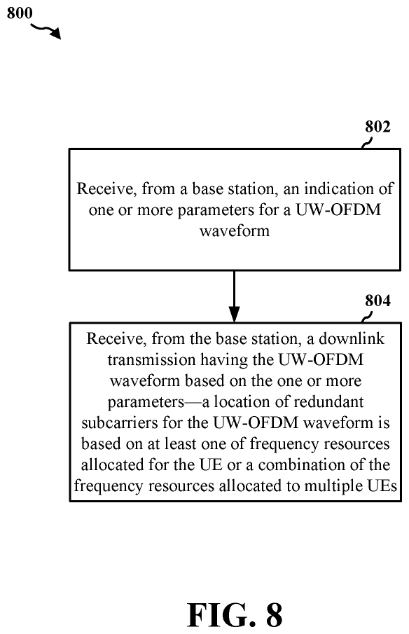

FIG. 8 is a flowchart 800 of a method of wireless communication. The method may be performed by a UE (e.g., the UE 104/402; the apparatus 1202; etc.), which may include the memory 360 and which may be the entire UE 104/402 or a component of the UE 104/402, such as the TX processor 368, the RX processor 356, and/or the controller/processor 359.

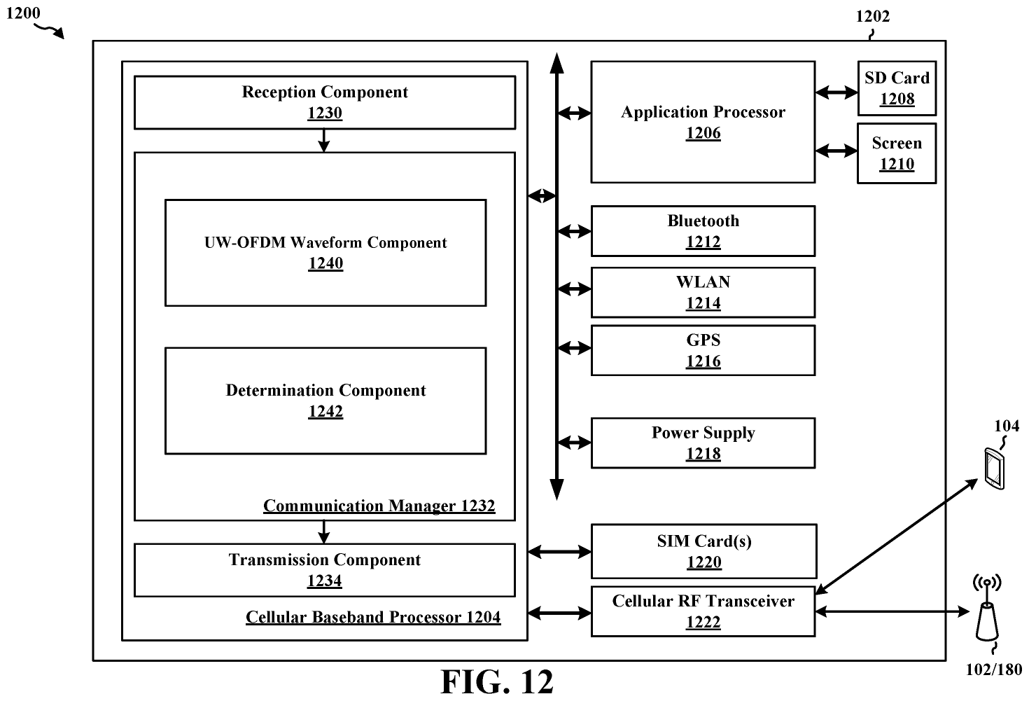

At 802, the UE may receive, from a base station, an indication of one or more parameters for a UW-OFDM waveform. For example, referring to FIG. 4, the UE 402 may receive, at 406, UW-OFDM waveform parameters from the base station 404. The reception, at 802, may be performed by the UW-OFDM waveform component 1240 of the apparatus 1202 in FIG. 12.

At 804, the UE may receive, from the base station, a downlink transmission having the UW-OFDM waveform based on the one or more parameters—a location of redundant subcarriers for the UW-OFDM waveform is based on at least one of frequency resources allocated for the UE or a combination of the frequency resources allocated to multiple UEs. For example, referring to FIGS. 4 and 7, the UE 402 may receive, at 414, from the base station 404, a UW-OFDM waveform based on the UW-OFDM waveform parameters received, at 406, where the UW-OFDM waveform may include redundant subcarriers associated with individual frequency allocations (e.g., as illustrated via the allocation 750) or based on a combined frequency allocation (e.g., as illustrated via the allocation 700). The reception, at 804, may be performed by the UW-OFDM waveform component 1240 of the apparatus 1202 in FIG. 12.

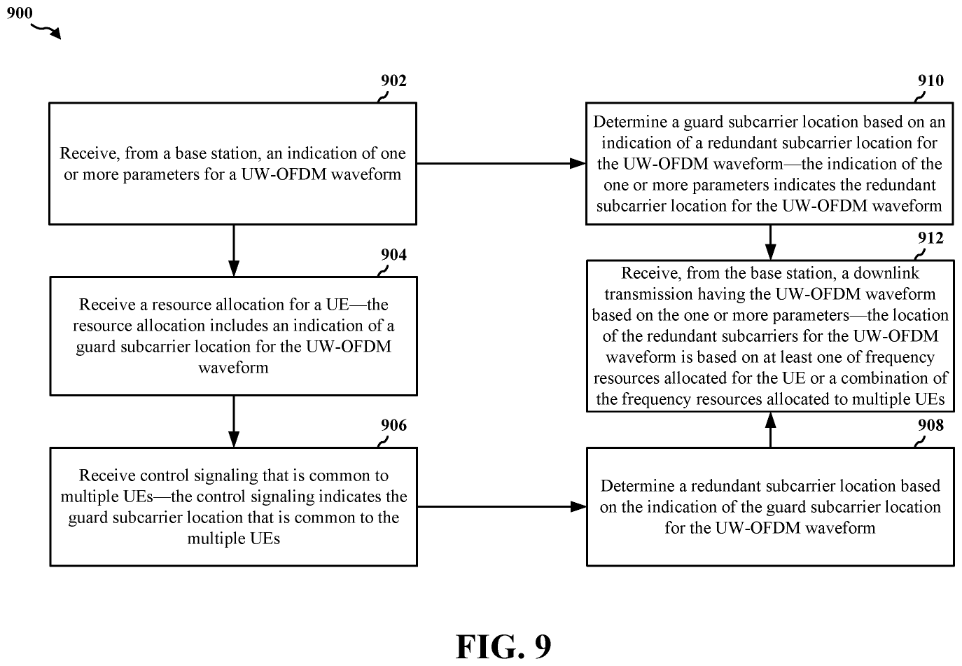

FIG. 9 is a flowchart 900 of a method of wireless communication. The method may be performed by a UE (e.g., the UE 104/402; the apparatus 1202; etc.), which may include the memory 360 and which may be the entire UE 104/402 or a component of the UE 104/402, such as the TX processor 368, the RX processor 356, and/or the controller/processor 359.

At 902, the UE may receive, from a base station, an indication of one or more parameters for a UW-OFDM waveform. For example, referring to FIG. 4, the UE 402 may receive, at 406, UW-OFDM waveform parameters from the base station 404. The one or more parameters received, at 406, may include one or more of: a time domain length of a guard interval for the UW-OFDM waveform, a number of redundant subcarriers for the UW-OFDM waveform, a redundant subcarrier location for the UW-OFDM waveform, a guard subcarrier location for the UW-OFDM waveform, a generation technique for the UW-OFDM waveform, a generation mechanism for a zero-tailed OFDM symbol for the UW-OFDM waveform, or information about a UW for the UW-OFDM waveform. The indication received, at 406, may indicate a guard subcarrier location for the UW-OFDM waveform. The indication received, at 406, may indicate a joint indication of a redundant subcarrier location and a guard subcarrier location for the UW-OFDM waveform. The reception, at 902, may be performed by the UW-OFDM waveform component 1240 of the apparatus 1202 in FIG. 12.

At 904, the UE may receive a resource allocation for a UE—the resource allocation includes an indication of a guard subcarrier location for the UW-OFDM waveform. For example, referring to FIG. 4, the UE 402 may receive, at 410, from the base station 404, an indication of guard subcarriers locations for one or more UEs. The reception, at 904, may be performed by the UW-OFDM waveform component 1240 of the apparatus 1202 in FIG. 12.

At 906, the UE may receive control signaling that is common to multiple UEs—the control signaling indicates the guard subcarrier location that is common to the multiple UEs. For example, referring to FIG. 4, the UE 402 may receive, at 410, from the base station 404, an indication of guard subcarriers locations for one or more UEs. The control signaling may include one or more of RRC signaling, a MAC-CE, or DCI. The reception, at 906, may be performed by the UW-OFDM waveform component 1240 of the apparatus 1202 in FIG. 12.

At 908, the UE may determine a redundant subcarrier location based on the indication of the guard subcarrier location for the UW-OFDM waveform. For example, referring to FIG. 4, the UE 402 may determine, at 412, redundant subcarrier locations based on the indication received, at 410, from the base station 404, of the guard subcarrier locations for the one or more UEs. The determination, at 908, may be performed by the determination component 1242 of the apparatus 1202 in FIG. 12.

At 910, the UE may determine a guard subcarrier location based on an indication of a redundant subcarrier location for the UW-OFDM waveform—the indication of the one or more parameters indicates the redundant subcarrier location for the UW-OFDM waveform. For example, referring to FIG. 4, the UE 402 may determine, at 408, guard subcarrier locations based on redundant subcarrier locations, which may be indicated via the UW-OFDM waveform parameters received, at 406, from the base station 404. For instance, a first redundant subcarrier location may correspond to an upper boundary of a data allocation and a second (e.g., last) redundant subcarrier location may correspond to a lower boundary of the data allocation, such that the UE 402 may determine the data allocation, which may be subtracted from an FFT bandwidth to determine, at 408, the guard subcarrier locations. The determination, at 910, may be performed by the determination component 1242 of the apparatus 1202 in FIG. 12.

At 912, the UE may receive, from the base station, a downlink transmission having the UW-OFDM waveform based on the one or more parameters—the location of the redundant subcarriers for the UW-OFDM waveform is based on at least one of frequency resources allocated for the UE or a combination of the frequency resources allocated to multiple UEs. For example, referring to FIGS. 4 and 7, the UE 402 may receive, at 414, from the base station 404, a UW-OFDM waveform based on the UW-OFDM waveform parameters received, at 406, where the UW-OFDM waveform may include redundant subcarriers associated with individual frequency allocations (e.g., as illustrated via the allocation 750) or based on a combined frequency allocation (e.g., as illustrated via the allocation 700). The location of the redundant subcarriers may be common to multiple UEs (e.g., as illustrated via the allocation 700). The guard subcarriers for the UW-OFDM waveform received, at 414, may correspond to non-allocated frequency resources that are not allocated to the UE. The guard subcarriers for the UW-OFDM waveform received, at 414, may correspond to non-allocated frequency resources that are not allocated to the multiple UEs. Redundant subcarrier locations may be a same location across multiple resource allocations for the UE 402. Redundant subcarrier locations may be indicated independently from the base station 404 for each resource allocation for the UE 402. The reception, at 912, may be performed by the UW-OFDM waveform component 1240 of the apparatus 1202 in FIG. 12.

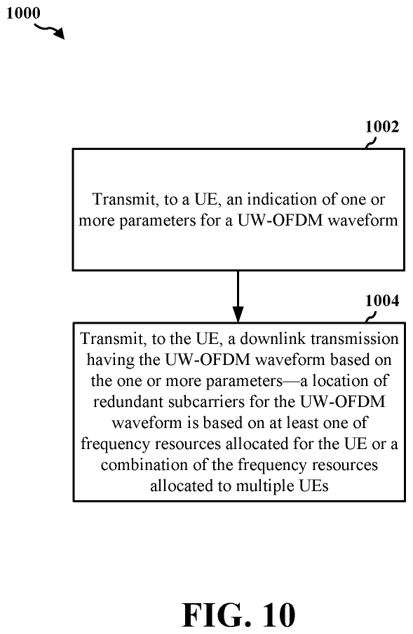

FIG. 10 is a flowchart 1000 of a method of wireless communication. The method may be performed by a base station (e.g., the base station 102/404; the apparatus 1302; etc.), which may include the memory 376 and which may be the entire base station 102/404 or a component of the base station 102/404, such as the TX processor 316, the RX processor 370, and/or the controller/processor 375.

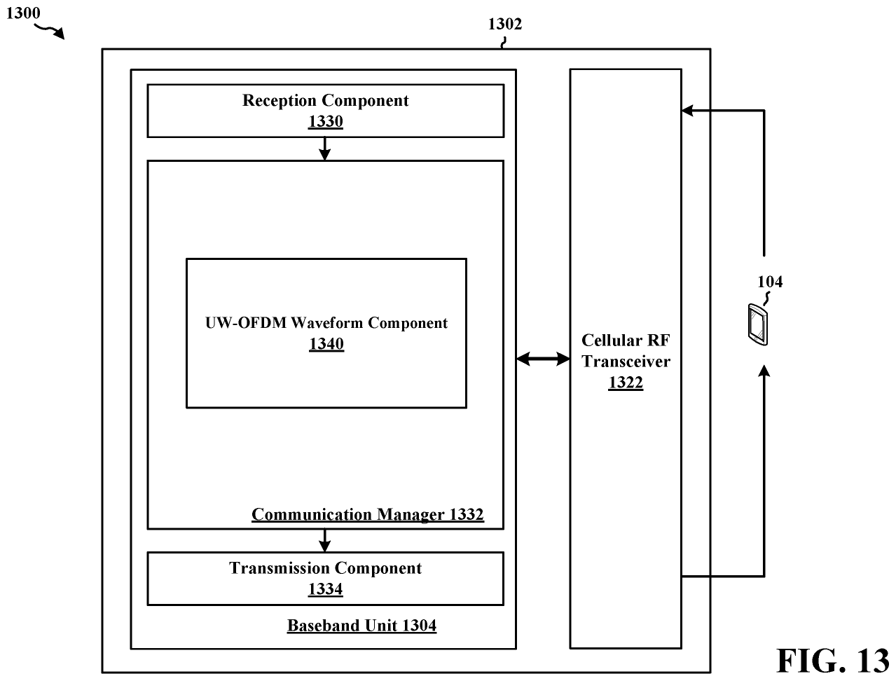

At 1002, the base station may transmit, to a UE, an indication of one or more parameters for a UW-OFDM waveform. For example, referring to FIG. 4, the base station 404 may transmit, at 406, UW-OFDM waveform parameters to the UE 402. The transmission, at 1002, may be performed by the UW-OFDM waveform component 1340 of the apparatus 1302 in FIG. 13.

At 1004, the base station may transmit, to the UE, a downlink transmission having the UW-OFDM waveform based on the one or more parameters—a location of redundant subcarriers for the UW-OFDM waveform is based on at least one of frequency resources allocated for the UE or a combination of the frequency resources allocated to multiple UEs. For example, referring to FIGS. 4 and 7, the base station 404 may transmit, at 414, to the UE 402, a UW-OFDM waveform based on the UW-OFDM waveform parameters transmitted, at 406, where the UW-OFDM waveform may include redundant subcarriers associated with individual frequency allocations (e.g., as illustrated via the allocation 750) or based on a combined frequency allocation (e.g., as illustrated via the allocation 700). The transmission, at 1004, may be performed by the UW-OFDM waveform component 1340 of the apparatus 1302 in FIG. 13.

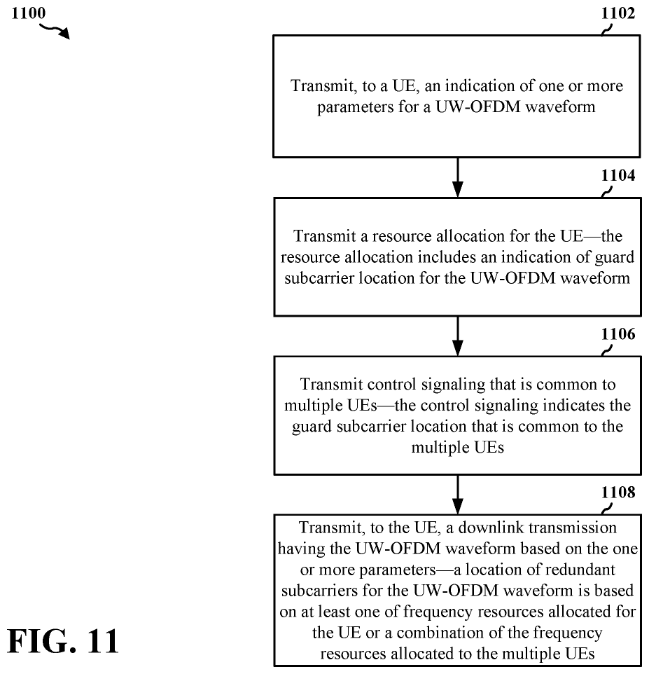

FIG. 11 is a flowchart 1100 of a method of wireless communication. The method may be performed by a base station (e.g., the base station 102/404; the apparatus 1302; etc.), which may include the memory 376 and which may be the entire base station 102/404 or a component of the base station 102/404, such as the TX processor 316, the RX processor 370, and/or the controller/processor 375.

At 1102, the base station may transmit, to a UE, an indication of one or more parameters for a UW-OFDM waveform. For example, referring to FIG. 4, the base station 404 may transmit, at 406, UW-OFDM waveform parameters to the UE 402. The one or more parameters transmitted, at 406, may include one or more of: a time domain length of a guard interval for the UW-OFDM waveform, a number of redundant subcarriers for the UW-OFDM waveform, a redundant subcarrier location for the UW-OFDM waveform, a guard subcarrier location for the UW-OFDM waveform, a generation technique for the UW-OFDM waveform, a generation mechanism for a zero-tailed OFDM symbol for the UW-OFDM waveform, or information about a UW for the UW-OFDM waveform. The indication transmitted, at 406, may indicate a redundant subcarrier location for the UW-OFDM waveform, such that a guard subcarrier location may be determined, at 408, based on the redundant subcarrier location indicated, at 406, to the UE 402 for the UW-OFDM waveform. The indication transmitted, at 406, may indicate a joint indication of a redundant subcarrier location and a guard subcarrier location for the UW-OFDM waveform. The transmission, at 1102, may be performed by the UW-OFDM waveform component 1340 of the apparatus 1302 in FIG. 13.

At 1104, the base station may transmit a resource allocation for the UE—the resource allocation includes an indication of guard subcarrier location for the UW-FDM waveform. For example, referring to FIG. 4, the base station 404 may transmit, at 410, to the UE 402, an indication of guard subcarriers locations for one or more UEs. The indication transmitted, at 410, may indicate a guard subcarrier location for the UW-OFDM waveform. The transmission, at 1104, may be performed by the UW-OFDM waveform component 1340 of the apparatus 1302 in FIG. 13.

At 1106, the base station may transmit control signaling that is common to multiple UEs—the control signaling indicates the guard subcarrier location that is common to the multiple UEs. For example, referring to FIG. 4, the base station 404 may transmit, at 410, to the UE 402, an indication of guard subcarrier locations for one or more UEs. The control signaling may include one or more of RRC signaling, a MAC-CE, or DCI. The transmission, at 1106, may be performed by the UW-OFDM waveform component 1340 of the apparatus 1302 in FIG. 13.

At 1108, the base station may transmit, to the UE, a downlink transmission having the UW-OFDM waveform based on the one or more parameters—a location of redundant subcarriers for the UW-OFDM waveform is based on at least one of frequency resources allocated for the UE or a combination of the frequency resources allocated to the multiple UEs. For example, referring to FIGS. 4 and 7, the base station 404 may transmit, at 414, to the UE 402, a UW-OFDM waveform based on the UW-OFDM waveform parameters transmitted, at 406, where the UW-OFDM waveform may include redundant subcarriers associated with individual frequency allocations (e.g., as illustrated via the allocation 750) or based on a combined frequency allocation (e.g., as illustrated via the allocation 700). The location of the redundant subcarriers may be common to the multiple UEs (e.g., as illustrated via the allocation 700). Guard subcarriers for the UW-OFDM waveform transmitted, at 414, may correspond to non-allocated frequency resources that are not allocated to the UE. Guard subcarriers for the UW-OFDM waveform transmitted, at 414, may correspond to non-allocated frequency resources that are not allocated to the multiple UEs. A redundant subcarrier location may be based on the guard subcarrier location indicated, at 410, to the UE 402 for the UW-OFDM waveform. A redundant subcarrier location may be a same location across multiple resource allocations for the UE 402. A redundant subcarrier location may be indicated independently by the base station 404 for each resource allocation for the UE 402. The transmission, at 1108, may be performed by the UW-OFDM waveform component 1340 of the apparatus 1302 in FIG. 13.

FIG. 12 is a diagram 1200 illustrating an example of a hardware implementation for an apparatus 1202. The apparatus 1202 may be a UE, a component of a UE, or may implement UE functionality. In some aspects, the apparatus 1202 may include a cellular baseband processor 1204 (also referred to as a modem) coupled to a cellular RF transceiver 1222. In some aspects, the apparatus 1202 may further include one or more subscriber identity modules (SIM) cards 1220, an application processor 1206 coupled to a secure digital (SD) card 1208 and a screen 1210, a Bluetooth module 1212, a wireless local area network (WLAN) module 1214, a Global Positioning System (GPS) module 1216, or a power supply 1218. The cellular baseband processor 1204 communicates through the cellular RF transceiver 1222 with the UE 104 and/or BS 102/180. The cellular baseband processor 1204 may include a computer-readable medium/memory. The computer-readable medium/memory may be non-transitory. The cellular baseband processor 1204 is responsible for general processing, including the execution of software stored on the computer-readable medium/memory. The software, when executed by the cellular baseband processor 1204, causes the cellular baseband processor 1204 to perform the various functions described supra. The computer-readable medium/memory may also be used for storing data that is manipulated by the cellular baseband processor 1204 when executing software. The cellular baseband processor 1204 further includes a reception component 1230, a communication manager 1232, and a transmission component 1234. The communication manager 1232 includes the one or more illustrated components. The components within the communication manager 1232 may be stored in the computer-readable medium/memory and/or configured as hardware within the cellular baseband processor 1204. The cellular baseband processor 1204 may be a component of the UE 350 and may include the memory 360 and/or at least one of the TX processor 368, the RX processor 356, and the controller/processor 359. In one configuration, the apparatus 1202 may be a modem chip and include just the baseband processor 1204, and in another configuration, the apparatus 1202 may be the entire UE (e.g., see 350 of FIG. 3) and include the additional modules of the apparatus 1202.

The communication manager 1232 includes a UW-OFDM waveform component 1240 that is configured, e.g., as described in connection with 802, 804, 902, 904, 906, and 912, to receive, from a base station, an indication of one or more parameters for a UW-OFDM waveform; to receive a resource allocation for a UE—the resource allocation includes an indication of a guard subcarrier location for the UW-OFDM waveform; to receive control signaling that is common to multiple UEs—the control signaling indicates the guard subcarrier location that is common to the multiple UEs; and to receive, from the base station, a downlink transmission having the UW-OFDM waveform based on the one or more parameters—the location of the redundant subcarriers for the UW-OFDM waveform is based on at least one of frequency resources allocated for the UE or a combination of the frequency resources allocated to multiple UEs. The communication manager 1232 further includes a determination component 1242 that is configured, e.g., as described in connection with 908 and 910, to determine a redundant subcarrier location based on the indication of the guard subcarrier location for the UW-OFDM waveform; and to determine a guard subcarrier location based on an indication of a redundant subcarrier location for the UW-OFDM waveform—the indication of the one or more parameters indicates the redundant subcarrier location for the UW-OFDM waveform.

The apparatus may include additional components that perform each of the blocks of the algorithm in the flowcharts of FIGS. 8-9. As such, each block in the flowcharts of FIGS. 8-9 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1202 may include a variety of components configured for various functions. In one configuration, the apparatus 1202, and in particular the cellular baseband processor 1204, includes means for receiving, from a base station, an indication of one or more parameters for a UW-OFDM waveform; and means for receiving, from the base station, a downlink transmission having the UW-OFDM waveform based on the one or more parameters, a location of redundant subcarriers for the UW-OFDM waveform based on at least one of frequency resources allocated for the UE or a combination of the frequency resources allocated to multiple UEs. The apparatus 1202 further includes means for receiving a resource allocation for the UE, the resource allocation including the indication of the guard subcarrier location for the UW-OFDM waveform. The apparatus 1202 further includes means for receiving control signaling that is common to the multiple UEs, the control signaling indicating the guard subcarrier location that is common to the multiple UEs. The apparatus 1202 further includes means for determining a redundant subcarrier location based on the indication of the guard subcarrier location for the UW-OFDM waveform. The apparatus 1202 further includes means for determining a guard subcarrier location based on the indication of the redundant subcarrier location for the UW-OFDM waveform.

The means may be one or more of the components of the apparatus 1202 configured to perform the functions recited by the means. As described supra, the apparatus 1202 may include the TX Processor 368, the RX Processor 356, and the controller/processor 359. As such, in one configuration, the means may be the TX Processor 368, the RX Processor 356, and the controller/processor 359 configured to perform the functions recited by the means.

FIG. 13 is a diagram 1300 illustrating an example of a hardware implementation for an apparatus 1302. The apparatus 1302 may be a base station, a component of a base station, or may implement base station functionality. In some aspects, the apparatus 1302 may include a baseband unit 1304. The baseband unit 1304 may communicate through a cellular RF transceiver 1322 with the UE 104. The baseband unit 1304 may include a computer-readable medium/memory. The baseband unit 1304 is responsible for general processing, including the execution of software stored on the computer-readable medium/memory. The software, when executed by the baseband unit 1304, causes the baseband unit 1304 to perform the various functions described supra. The computer-readable medium/memory may also be used for storing data that is manipulated by the baseband unit 1304 when executing software. The baseband unit 1304 further includes a reception component 1330, a communication manager 1332, and a transmission component 1334. The communication manager 1332 includes the one or more illustrated components. The components within the communication manager 1332 may be stored in the computer-readable medium/memory and/or configured as hardware within the baseband unit 1304. The baseband unit 1304 may be a component of the base station 310 and may include the memory 376 and/or at least one of the TX processor 316, the RX processor 370, and the controller/processor 375.

The communication manager 1332 includes a UW-OFDM waveform component 1340 that is configured, e.g., as described in connection with 1002, 1004, 1102, 1104, 1106, and 1108, to transmit, to a UE, an indication of one or more parameters for a UW-OFDM waveform; to transmit a resource allocation for the UE—the resource allocation includes an indication of guard subcarrier location for the UW-OFDM waveform; to transmit control signaling that is common to multiple UEs—the control signaling indicates the guard subcarrier location that is common to the multiple UEs; and to transmit, to the UE, a downlink transmission having the UW-OFDM waveform based on the one or more parameters—a location of redundant subcarriers for the UW-OFDM waveform is based on at least one of frequency resources allocated for the UE or a combination of the frequency resources allocated to the multiple UEs.

The apparatus may include additional components that perform each of the blocks of the algorithm in the flowcharts of FIGS. 10-11. As such, each block in the flowcharts of FIGS. 10-11 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1302 may include a variety of components configured for various functions. In one configuration, the apparatus 1302, and in particular the baseband unit 1304, includes means for transmitting, to a UE, an indication of one or more parameters for a UW-OFDM waveform; and means for transmitting, to the UE, a downlink transmission having the UW-OFDM waveform based on the one or more parameters, a location of redundant subcarriers for the UW-OFDM waveform based on at least one of frequency resources allocated for the UE or a combination of the frequency resources allocated to multiple UEs. The apparatus 1302 further includes means for transmitting a resource allocation for the UE, the resource allocation including the indication of the guard subcarrier location for the UW-OFDM waveform. The apparatus 1302 further includes means for transmitting control signaling that is common to the multiple UEs, the control signaling indicating the guard subcarrier location that is common to the multiple UEs.

The means may be one or more of the components of the apparatus 1302 configured to perform the functions recited by the means. As described supra, the apparatus 1302 may include the TX Processor 316, the RX Processor 370, and the controller/processor 375. As such, in one configuration, the means may be the TX Processor 316, the RX Processor 370, and the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.

Aspect 1 is an apparatus for wireless communication at a UE including at least one processor coupled to a memory and configured to: receive, from a base station, an indication of one or more parameters for a UW-OFDM waveform; and receive, from the base station, a downlink transmission having the UW-OFDM waveform based on the one or more parameters, a location of redundant subcarriers for the UW-OFDM waveform based on at least one of frequency resources allocated for the UE or a combination of the frequency resources allocated to multiple UEs.

Aspect 2 may be combined with aspect 1 and includes that the one or more parameters include one or more of a time domain length of a guard interval for the UW-OFDM waveform, a number of redundant subcarriers for the UW-OFDM waveform, a redundant subcarrier location for the UW-OFDM waveform, a guard subcarrier location for the UW-OFDM waveform, a generation technique for the UW-OFDM waveform, a generation mechanism for a zero-tailed OFDM symbol for the UW-OFDM waveform, or information about a UW for the UW-OFDM waveform.

Aspect 3 may be combined with any of aspects 1-2 and includes that the location of the redundant subcarriers is common to the multiple UEs.

Aspect 4 may be combined with any of aspects 1-3 and includes that guard subcarriers for the UW-OFDM waveform correspond to non-allocated frequency resources that are not allocated to the multiple UEs.

Aspect 5 may be combined with any of aspects 1-2 and includes that guard subcarriers for the UW-OFDM waveform correspond to non-allocated frequency resources that are not allocated to the UE.

Aspect 6 may be combined with any of aspects 1-5 and includes that the indication indicates a guard subcarrier location for the UW-OFDM waveform.

Aspect 7 may be combined with any of aspects 1-6 and includes that the at least one processor is further configured to receive a resource allocation for the UE, the resource allocation including the indication of the guard subcarrier location for the UW-OFDM waveform.

Aspect 8 may be combined with any of aspects 1-7 and includes that the at least one processor is further configured to receive control signaling that is common to the multiple UEs, the control signaling indicating the guard subcarrier location that is common to the multiple UEs.

Aspect 9 may be combined with any of aspects 1-8 and includes that the control signaling includes one or more of RRC signaling, a MAC-CE, or DCI.

Aspect 10 may be combined with any of aspects 1-9 and includes that the at least one processor is further configured to determining a redundant subcarrier location based on the indication of the guard subcarrier location for the UW-OFDM waveform.

Aspect 11 may be combined with any of aspects 1-10 and includes that the indication indicates a redundant subcarrier location for the UW-OFDM waveform, the at least one processor further configured to determine a guard subcarrier location based on the indication of the redundant subcarrier location for the UW-OFDM waveform.

Aspect 12 may be combined with any of aspects 1-11 and includes that the indication indicates a joint indication of a redundant subcarrier location and a guard subcarrier location for the UW-OFDM waveform.

Aspect 13 may be combined with any of aspects 1-12 and includes that a redundant subcarrier location is a same location across multiple resource allocations for the UE.

Aspect 14 may be combined with any of aspects 1-13 and includes that a redundant subcarrier location is indicated independently for each resource allocation for the UE.

Aspect 15 is an apparatus for wireless communication at a base station including at least one processor coupled to a memory and configured to: transmit, to a UE, an indication of one or more parameters for a UW-OFDM waveform; and transmit, to the UE, a downlink transmission having the UW-OFDM waveform based on the one or more parameters, a location of redundant subcarriers for the UW-OFDM waveform based on at least one of frequency resources allocated for the UE or a combination of the frequency resources allocated to multiple UEs.

Aspect 16 may be combined with aspect 15 and includes that the one or more parameters include one or more of: a time domain length of a guard interval for the UW-OFDM waveform, a number of redundant subcarriers for the UW-OFDM waveform, a redundant subcarrier location for the UW-OFDM waveform, a guard subcarrier location for the UW-OFDM waveform, a generation technique for the UW-OFDM waveform, a generation mechanism for a zero-tailed OFDM symbol for the UW-OFDM waveform, or information about a UW for the UW-OFDM waveform.

Aspect 17 may be combined with any of aspects 15-16 and includes that the location of the redundant subcarriers is common to the multiple UEs.

Aspect 18 may be combined with any of aspects 15-17 and includes that guard subcarriers for the UW-OFDM waveform correspond to non-allocated frequency resources that are not allocated to the multiple UEs.

Aspect 19 may be combined with any of aspects 15-16 and includes that guard subcarriers for the UW-OFDM waveform correspond to non-allocated frequency resources that are not allocated to the UE.

Aspect 20 may be combined with any of aspects 15-19 and includes that the indication indicates a guard subcarrier location for the UW-OFDM waveform.

Aspect 21 may be combined with any of aspects 15-20 and includes that the at least one processor is further configured to transmit a resource allocation for the UE, the resource allocation including the indication of the guard subcarrier location for the UW-OFDM waveform.

Aspect 22 may be combined with any of aspects 15-21 and includes that the at least one processor is further configured to transmit control signaling that is common to the multiple UEs, the control signaling indicating the guard subcarrier location that is common to the multiple UEs.

Aspect 23 may be combined with any of aspects 15-22 and includes that the control signaling includes one or more of RRC signaling, a MAC-CE, or DCI.

Aspect 24 may be combined with any of aspects 15-23 and includes that a redundant subcarrier location is based on the guard subcarrier location indicated to the UE for the UW-OFDM waveform.

Aspect 25 may be combined with any of aspects 15-24 and includes that the indication indicates a redundant subcarrier location for the UW-OFDM waveform, and a guard subcarrier location is based on the redundant subcarrier location indicated to the UE for the UW-OFDM waveform.

Aspect 26 may be combined with any of aspects 15-25 and includes that the indication indicates a joint indication of a redundant subcarrier location and a guard subcarrier location for the UW-OFDM waveform.

Aspect 27 may be combined with any of aspects 15-26 and includes that a redundant subcarrier location is a same location across multiple resource allocations for the UE.

Aspect 28 may be combined with any of aspects 15-27 and includes that a redundant subcarrier location is indicated independently for each resource allocation for the UE.

Aspect 29 may be combined with any of aspects 1-28 and further includes at least one of an antenna or a transceiver coupled to the at least one processor.

Aspect 30 is a method of wireless communication for implementing any of aspects 1-29.

Aspect 31 is an apparatus for wireless communication including means for implementing any of aspects 1-29.

Aspect 32 is a computer-readable medium storing computer executable code, the code when executed by at least one processor causes the at least one processor to implement any of aspects 1-29.

What is claimed is:

1. An apparatus for wireless communication at a user equipment (UE), comprising:
a memory; and
at least one processor coupled to the memory and configured to:
receive, from a base station, an indication of one or more parameters for a unique word orthogonal frequency division multiple access (UW-OFDM) waveform; and
receive, from the base station, a downlink transmission having the UW-OFDM waveform based on the one or more parameters, a location of redundant subcarriers for the UW-OFDM waveform based on at least one of frequency resources allocated for the UE or a combination of the frequency resources allocated to multiple UEs.

2. The apparatus of claim 1, wherein the one or more parameters include one or more of:
a time domain length of a guard interval for the UW-OFDM waveform,
a number of redundant subcarriers for the UW-OFDM waveform,
a redundant subcarrier location for the UW-OFDM waveform,
a guard subcarrier location for the UW-OFDM waveform,
a generation technique for the UW-OFDM waveform,
a generation mechanism for a zero-tailed OFDM symbol for the UW-OFDM waveform, or
information about a unique word (UW) for the UW-OFDM waveform.

3. The apparatus of claim 1, wherein the location of the redundant subcarriers is common to the multiple UEs.

4. The apparatus of claim 1, wherein guard subcarriers for the UW-OFDM waveform correspond to non-allocated frequency resources that are not allocated to the multiple UEs.

5. The apparatus of claim 1, wherein guard subcarriers for the UW-OFDM waveform correspond to non-allocated frequency resources that are not allocated to the UE.

6. The apparatus of claim 1, wherein the indication indicates a guard subcarrier location for the UW-OFDM waveform.

7. The apparatus of claim 6, wherein the at least one processor is further configured to receive a resource allocation for the UE, the resource allocation including the indication of the guard subcarrier location for the UW-OFDM waveform.

8. The apparatus of claim 6, wherein the at least one processor is further configured to receive control signaling that is common to the multiple UEs, the control signaling indicating the guard subcarrier location that is common to the multiple UEs.

9. The apparatus of claim 8, wherein the control signaling includes one or more of radio resource control (RRC) signaling, a medium access control-control element (MAC-CE), or downlink control information (DCI).

10. The apparatus of claim 6, wherein the at least one processor is further configured to determining a redundant subcarrier location based on the indication of the guard subcarrier location for the UW-OFDM waveform.

11. The apparatus of claim 1, wherein the indication indicates a redundant subcarrier location for the UW-OFDM waveform, the at least one processor further configured to determine a guard subcarrier location based on the indication of the redundant subcarrier location for the UW-OFDM waveform.

12. The apparatus of claim 1, wherein the indication indicates a joint indication of a redundant subcarrier location and a guard subcarrier location for the UW-OFDM waveform.

13. The apparatus of claim 1, wherein a redundant subcarrier location is a same location across multiple resource allocations for the UE.

14. The apparatus of claim 1, wherein a redundant subcarrier location is indicated independently for each resource allocation for the UE.

15. An apparatus for wireless communication at a base station, comprising:
a memory; and
at least one processor coupled to the memory and configured to:
transmit, to a user equipment (UE), an indication of one or more parameters for a unique word orthogonal frequency division multiple access (UW-OFDM) waveform; and
transmit, to the UE, a downlink transmission having the UW-OFDM waveform based on the one or more parameters, a location of redundant subcarriers for the UW-OFDM waveform based on at least one of frequency resources allocated for the UE or a combination of the frequency resources allocated to multiple UEs.

16. The apparatus of claim 15, wherein the one or more parameters include one or more of:
a time domain length of a guard interval for the UW-OFDM waveform,
a number of redundant subcarriers for the UW-OFDM waveform,
a redundant subcarrier location for the UW-OFDM waveform,
a guard subcarrier location for the UW-OFDM waveform,
a generation technique for the UW-OFDM waveform,
a generation mechanism for a zero-tailed OFDM symbol for the UW-OFDM waveform, or
information about a unique word (UW) for the UW-OFDM waveform.

17. The apparatus of claim 15, wherein the location of the redundant subcarriers is common to the multiple UEs.

18. The apparatus of claim 15, wherein guard subcarriers for the UW-OFDM waveform correspond to non-allocated frequency resources that are not allocated to the multiple UEs.

19. The apparatus of claim 15, wherein guard subcarriers for the UW-OFDM waveform correspond to non-allocated frequency resources that are not allocated to the UE.

20. The apparatus of claim 15, wherein the indication indicates a guard subcarrier location for the UW-OFDM waveform.

21. The apparatus of claim 20, wherein the at least one processor is further configured to transmit a resource allocation for the UE, the resource allocation including the indication of the guard subcarrier location for the UW-OFDM waveform.

22. The apparatus of claim 20, wherein the at least one processor is further configured to transmit control signaling that is common to the multiple UEs, the control signaling indicating the guard subcarrier location that is common to the multiple UEs.

23. The apparatus of claim 22, wherein the control signaling includes one or more of radio resource control (RRC) signaling, a medium access control-control element (MAC-CE), or downlink control information (DCI).

24. The apparatus of claim 20, wherein a redundant subcarrier location is based on the guard subcarrier location indicated to the UE for the UW-OFDM waveform.

25. The apparatus of claim 15, wherein the indication indicates a redundant subcarrier location for the UW-OFDM waveform, and a guard subcarrier location is based on the redundant subcarrier location indicated to the UE for the UW-OFDM waveform.

26. The apparatus of claim 15, wherein the indication indicates a joint indication of a redundant subcarrier location and a guard subcarrier location for the UW-OFDM waveform.

27. The apparatus of claim 15, wherein a redundant subcarrier location is a same location across multiple resource allocations for the UE.

28. The apparatus of claim 15, wherein a redundant subcarrier location is indicated independently for each resource allocation for the UE.

29. A method of wireless communication at a user equipment (UE), comprising:
receiving, from a base station, an indication of one or more parameters for a unique word orthogonal frequency division multiple access (UW-OFDM) waveform; and
receiving, from the base station, a downlink transmission having the UW-OFDM waveform based on the one or more parameters, a location of redundant subcarriers for the UW-OFDM waveform based on at least one of frequency resources allocated for the UE or a combination of the frequency resources allocated to multiple UEs.

30. A method of wireless communication at a base station, comprising:
transmitting, to a user equipment (UE), an indication of one or more parameters for a unique word orthogonal frequency division multiple access (UW-OFDM) waveform; and
transmitting, to the UE, a downlink transmission having the UW-OFDM waveform based on the one or more parameters, a location of redundant subcarriers for the UW-OFDM waveform based on at least one of frequency resources allocated for the UE or a combination of the frequency resources allocated to multiple UEs.
